(19) United States
(12) Patent Application Publication
(10) Pub. No.: US 2018/0247672 A1
(43) Pub. Date: Aug. 30, 2018

(54) Bundling Separate Video Files to Support a Controllable End-User Viewing Experience with Frame-Level Synchronization

(71) Applicant: ENTRY POINT VR, INC., New York, NY (US)

(72) Inventors: Ben Doyle, New York, NY (US); Carissa Flocken, New York, NY (US)

(21) Appl. No.: 15/902,853

(22) Filed: Feb. 22, 2018

Related U.S. Application Data
(60) Provisional application No. 62/463,485, filed on Feb. 24, 2017.

(51) Int. Cl. G11B 27/031; G06F 17/30

(52) U.S. Cl. CPC G11B 27/031; G11B 27/10; G06F 17/30781

(57) ABSTRACT

A video authoring application combines a plurality of individual video files into a bundled video file. The combination is performed on a frame-by-frame basis by horizontally and/or vertically stacking the frames of the individual video files together to assemble a bundled frame. The sequence of bundled frames is encoded by a transcoder to produce the bundled video file. The video authoring application also creates video definition data, which specifies the positional locations or areas of each of the individual video file frames within the bundled video file frames. Using the video frame definition data, the individual bundled frames can be extracted from the decoded bundled video file. The bundling of the multiple individual video files into a single file enables an end user to dynamically switch between the different individual files while maintaining time and audio synchronization between the files during playback.

### RELATED APPLICATIONS

The subject matter of this application is related to U.S. Provisional Application No. 62/463,485, filed on 2017-02-24, which is hereby incorporated by reference in its entirety.

### SUMMARY OF THE INVENTION

A video authoring application combines a plurality of individual video files into a bundled video file. The combination is performed on a frame-by-frame basis by horizontally and/or vertically stacking the frames of the individual video files together to assemble a bundled frame. The sequence of bundled frames is encoded by a transcoder to produce the bundled video file. The video authoring application also creates video definition data, which specifies the positional locations or areas of each of the individual video file frames within the bundled video file frames. Using the video frame definition data, the individual bundled frames can be extracted from the decoded bundled video file. The bundling of the multiple individual video files into a single file enables an end user to dynamically switch between the different individual files while maintaining time and audio synchronization between the files during playback.

A method includes: positionally stacking time-correlated frames of a plurality of video source files to create an encoded bundled video file; for each of the plurality of video source files, storing position data that specifies a positional location of the frames of the video source file within frames of the bundled video file; decoding the encoded bundled video file; accessing the stored position data for at least one of the video source files; based on the accessed position data, mapping a first area of pixels from the decoded bundled video file for display in a user interface; receiving user input subsequent to the mapping a first area of pixels; and based on the received user input and based on the accessed position data, mapping a second area of pixels from the decoded bundled video file for display in the user interface.

The method can be performed such that the bundled video file includes a plurality of encoded frames, and such that each encoded frame contains video content represents at least a portion of each of the plurality of video source files.

The method can be performed such that the position data is stored in a data file, and the method can further include accessing the data file to retrieve the position data for at least one of the video source files.

The method can be performed such that the first area of pixels from the decoded bundled video file is displayed in the user interface in an area that overlays at least a portion of an area in the user interface in which the second area of pixels from the decoded bundled video file is displayed.

The method can be performed such that the first area of pixels and the second area of pixels from the decoded bundled video file are displayed simultaneously in the user interface.

The method can be performed such that the second area of pixels from the decoded bundled video file replaces the first area of pixels from the decoded bundled video file in the user interface.

The method can be performed such that the user input comprises selection of an icon overlaying the first area of pixels as mapped for display in the user interface, and such that the icon is associated with a position, within the first area of pixels, of a camera that captured the second area of pixels.

The method can be performed such that the first area of pixels is associated with a first of the plurality of video source files, and such that the second area of pixels is associated with a second of the plurality of video source files.

The method can be performed such that the position data includes coordinate locations within a frame.

A system includes: an authoring computing device configured for: positionally stacking time-correlated frames of a plurality of video source files to create an encoded bundled video file, and for each of the plurality of video source files, storing position data that specifies a positional location of the frames of the video source file within frames of the bundled video file; a database storing presentation data files comprising the position data; and an end user computing device configured for: decoding the encoded bundled video file, accessing the stored position data for at least one of the video source files, based on the accessed position data, mapping a first area of pixels from the decoded bundled video file for display in a user interface, receiving user input subsequent to the mapping a first area of pixels, and based on the received user input and based on the accessed position data, mapping a second area of pixels from the decoded bundled video file for display in the user interface.

A set of one or more non-transitory computer readable media can store instructions that when executed by one or more computing devices cause the computer devices to: positionally stack time-correlated frames of a plurality of video source files to create an encoded bundled video file; for each of the plurality of video source files, store position data that specifies a positional location of the frames of the video source file within frames of the bundled video file; decode the encoded bundled video file; access the stored position data for at least one of the video source files; based on the accessed position data, map a first area of pixels from the decoded bundled video file for display in a user interface; receive user input subsequent to the mapping a first area of pixels; and based on the received user input and based on the accessed position data, map a second area of pixels from the decoded bundled video file for display in the user interface.

### BRIEF DESCRIPTION OF THE DRAWINGS

FIG. 1 illustrates a schematic visualization of a process for combining separate video streams or files into a bundled video stream or file.

FIG. 2 illustrates an architecture of a system that can be used to perform the process of FIG. 1.

FIGS. 3A-B illustrate two end-user views from a bundled video file of a music concert.

FIG. 4A shows a corresponding frame of an equirectangular projection from an individual video source file.

FIG. 4B shows a corresponding frame of a standard video feed individual video source file from which a picture-in-picture feed would normally be obtained.

FIG. 5 shows a corresponding frame of the bundled video file that is created from a 360 degree video source file and the standard video feed individual video source file.

FIG. 6 illustrates a map of the two end user views shown in FIGS. 3A-B.

FIG. 7 illustrates a frame of a bundled video file that includes three equirectangular projection 360 degree video source files stacked vertically.

FIG. 8 illustrates a map of the bundled video file showing how portions of the frame of FIG. 7 map to the views shown in FIGS. 9A-D.

FIGS. 9A-D show different views produced by an application based on the frame of FIG. 7.

FIG. 10 illustrates an example computer that can be used to implement various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted.

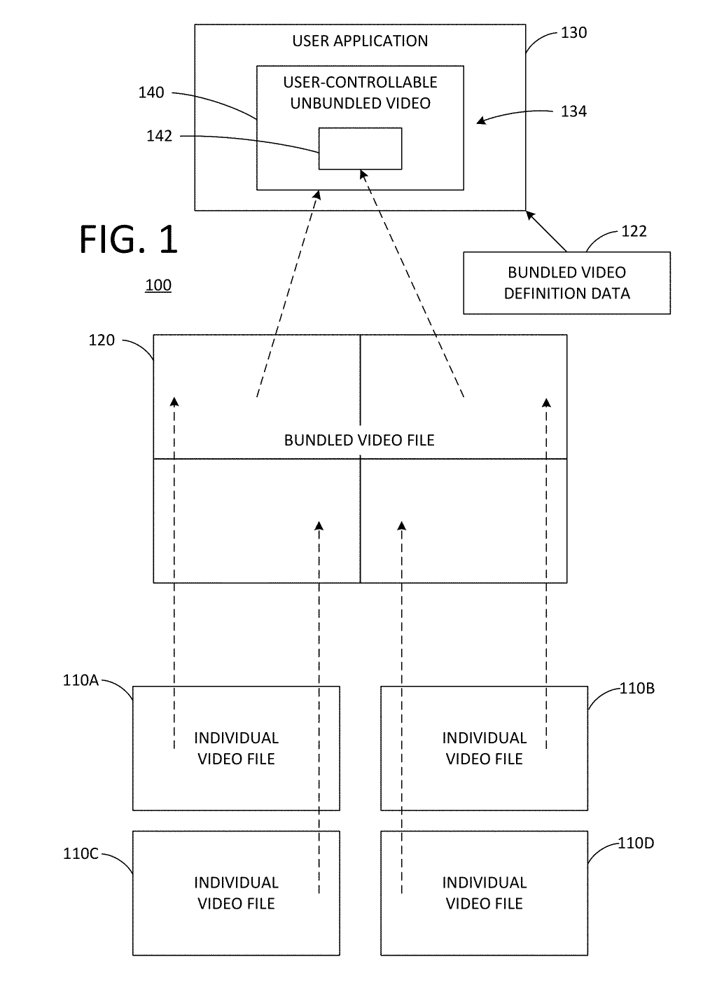

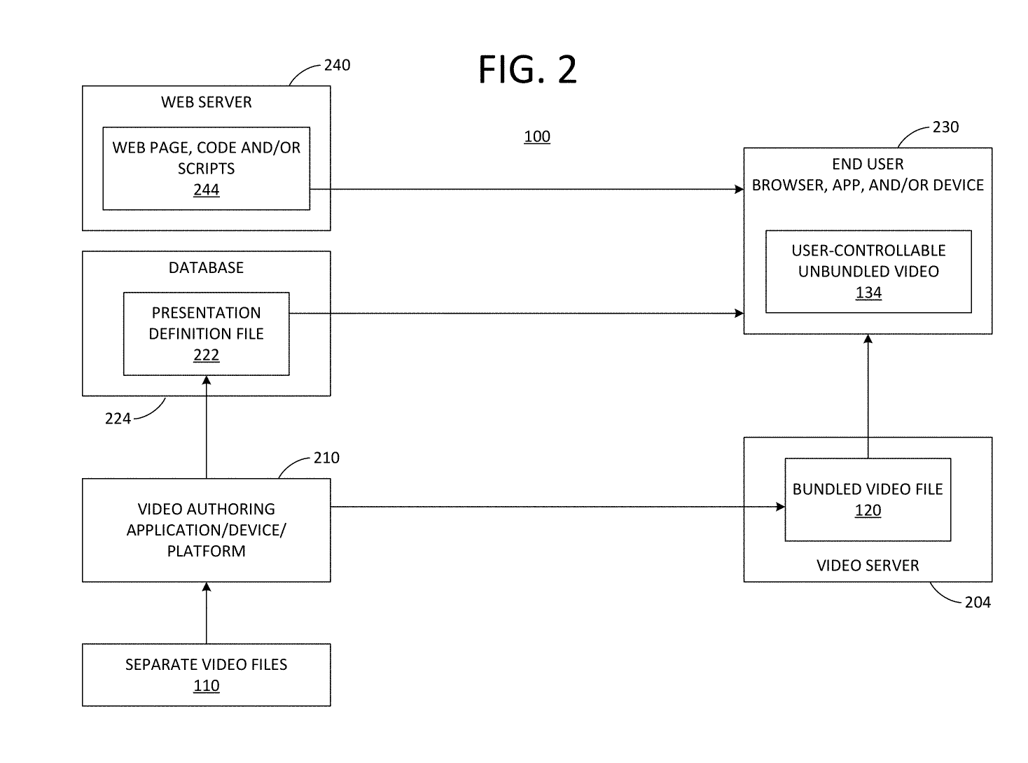

FIG. 1 illustrates a schematic visualization of a process 100, in accordance with one embodiment, for combining separate video streams or files into a bundled video stream or file, which in turn supports a user-controllable frame-synchronized video experience. FIG. 2 illustrates an architecture of a system 200 that can be used to perform the process 100 in accordance with one embodiment. Referring to FIGS. 1 and 2, the process 100 will now be described in conjunction with the system 200.

A video authoring application, device and/or platform 210 combines a plurality of individual video files 110A-D into a bundled video file 120. The combination is performed on a frame-by-frame basis by horizontally and/or vertically stacking the frames of the individual video files together to create a bundled frame. The sequence of bundled frames is encoded by a transcoder to produce the bundled video file 120 and the bundled video file can then be decoded to obtain the individual bundled frames. The resolution of each of the individual video files can be preserved in the bundled video file.

As illustrated in FIG. 1, for example, each frame of each of four equal resolution and aspect ratio individual video files can be combined in their original resolution in each of four equivalent quadrants of a frame in the resulting bundled video file that has twice the vertical and twice the horizontal resolution of the individual video files. The resolution of one or more of the individual video files can alternatively be modified or selected so that the individual video files occupy unequal portions of each frame of the resulting bundled video file.

The bundled video file 120 can be stored on a video server 204 for access by end users. As will be understood by one skilled in the art, references herein to video files should be understood to also apply to video streams that include a sequence of frames received, transmitted, and/or processed on a streaming basis.

The stacking and optional resizing of the frames can be performed using the ffmpeg video transcoder. The ffmpeg transcoder provides the hstack and vstack filters, which enable multiple video files to be stacked horizontally and vertically. The ffmpeg transcoder also provides filters that support resizing. The video authoring application, device and/or platform 210 can be configured to perform the combination based on manual control by an authoring user or programmatically by an application program or script, optionally configured through configuration settings.

The video authoring application, device and/or platform 210 and/or the authoring user also creates bundled video definition data 122, which specifies the positional locations or areas of each of the individual video file frames within the bundled video file frames. The bundled video definition data 122 can be subsequently used to identify and extract the individual video files 110 from the bundled video file 120 for presentation to an end-user. The bundled video definition data 122 can be stored in and/or incorporated into a presentation definition file or data file 222, which in turn can be stored in a database 224. The presentation definition file 222 can define a specific end-user layout and/or control functionality for manipulating the bundled video file 120 based on the video definition data 122.

The bundled video definition data 122 can include an identification of each of the individual video files included in the bundled video file. The identification can be a name, number or globally unique identifier or another identifier. The bundled video definition data can also include, for each of the individual video files included in the bundled video file, a position occupied by the frames or pixels of the individual video file within the frames of the bundled video file. The position be specified, for example by lower right coordinates and an upper left coordinates for the frames for each of the individual video files in the bundle. The bundled video definition data can also include, for each of the individual video files included in the bundled video file, other information useful in using or decoding the individual video files, such as resolution, aspect ratio, or which audio tracks are associated with the individual files.

The multiple bundled video files can be created to share a common audio track or tracks within the bundled video file. Alternatively or additionally, multiple audio tracks associated with the bundled files can be incorporated into the bundled video file and optionally selected by the end-user for presentation.

An end user using an application 130 or configured device 230 can access the bundled video file 120, from the video server 204, and the presentation definition file 222, from the database 224, in order to display user-controllable unbundled video 134. In one embodiment, an end user uses a web browser as the application 130 to access a web server 240 configured to host a web page 244 that supports end-user access and control of the bundled video. The web page 244 can include code and/or scripts that cause the web browser 130 to retrieve the presentation definition file 222 and/or the bundled video definition data 122. The presentation definition file 222 and/or the bundled video definition data 122 can in turn provide a link to the bundled video file 120 on the web server 204. The web browser can then interpret the web page 244, the presentation definition file 222 and/or the bundled video definition data 122 to provide the end user the ability to access and control use of the content in the bundled video file 120. In one embodiment, the application 130 can be a dedicated application, such as an app executing on a mobile device, and the dedicated application can be configured to access the presentation definition file 222 and the bundled video file 120 and provide access and control of the bundled video to the user without needing a web server 240 or web page 244.

Referring to FIG. 1, for example, the frames of the individual video files 110A-D are respectively arranged in the upper left, upper right, lower left and lower right quadrants of the bundled video file. As shown schematically in FIG. 1, the user application 130 has been configured to select the individual video file 110A from the upper left quadrant of the bundled video file 120 for display to a user in a larger or outer display frame 140 of the user-controllable unbundled video 134. The individual video file 110B extracted from the upper right quadrant of the bundled video file is also shown, but in a picture-in-picture format window 142 within the outer display frame 140.

The user application 130 can be configured to give the end user control over selecting among one or more of the individual video files for display and configuring how or where to display the selected individual video files. For example, as in the example illustrated in FIG. 1, alternate ones of the individual video files included in the bundled video file 120 can be selected by the user to be swapped into the outer display frame 140 or the picture-in-picture format window 142. The configuration can be adjusted to display two or more videos side by side, atop one another or in other configurations of various sizes, orientations and overlays.

The application 130 can also be configured to support the user selecting portions of the individual video files to be displayed and/or transforming or mapping those portions, such as to support 360 degree user-selectable video. In the case of a 360 degree video, a video feed supplied by a 360 degree camera is mapped onto a rectangular aspect ratio video transport frame, the user is given the ability to control a perspective or orientation to be viewed, and then a mapping is performed to extract and transform the appropriate portion of rectangular aspect ratio video transport frame back to a final end-user perspective of the selected orientation. The bundled video file and application can also be configured to support stereoscopic devices and/or 360 degree virtual reality video such as stereoscopic headsets with orientation sensing capability.

Although individual video files can be supplied to and controlled by an end-user device or application without bundling, there are some particular advantages to bundling the individual video files into a single file. First, by bundling multiple video files, synchronization between the files can be enforced and maintained on a frame-by-frame basis. For example, multiple bundled video files can be sourced from a single event where the different files represent different camera views of the event and all camera feeds are synchronized in time. The bundled video file is then created using the different files synchronized to a common start time. The multiple camera views can then be made available for an end user to display and/or control, with two or more views being displayed simultaneously and/or by swapping or switching between two or more views. Each frame of the bundled video file can be decoded to produce all of the time-synchronized frames of the multiple bundled video files. Doing this avoids delays and/or jitter that could otherwise be introduced between the various files due to decoding and/or transmission. By using the bundled video file, a default audio track or tracks selected by the end user are also automatically synchronized across the multiple bundled video files.

A second benefit to bundling is that many devices, such as certain smartphones and tablets, only have the hardware or software capability to decode a single video stream at a time. By bundling multiple individual video files into one, these limited devices can decode the bundled video to produce video frames that include the frames of the individual bundled videos, which can then be displayed to the user based on the user's control of the application 130. On such devices, a second video stream would not otherwise be able to be shown to the user simultaneously.

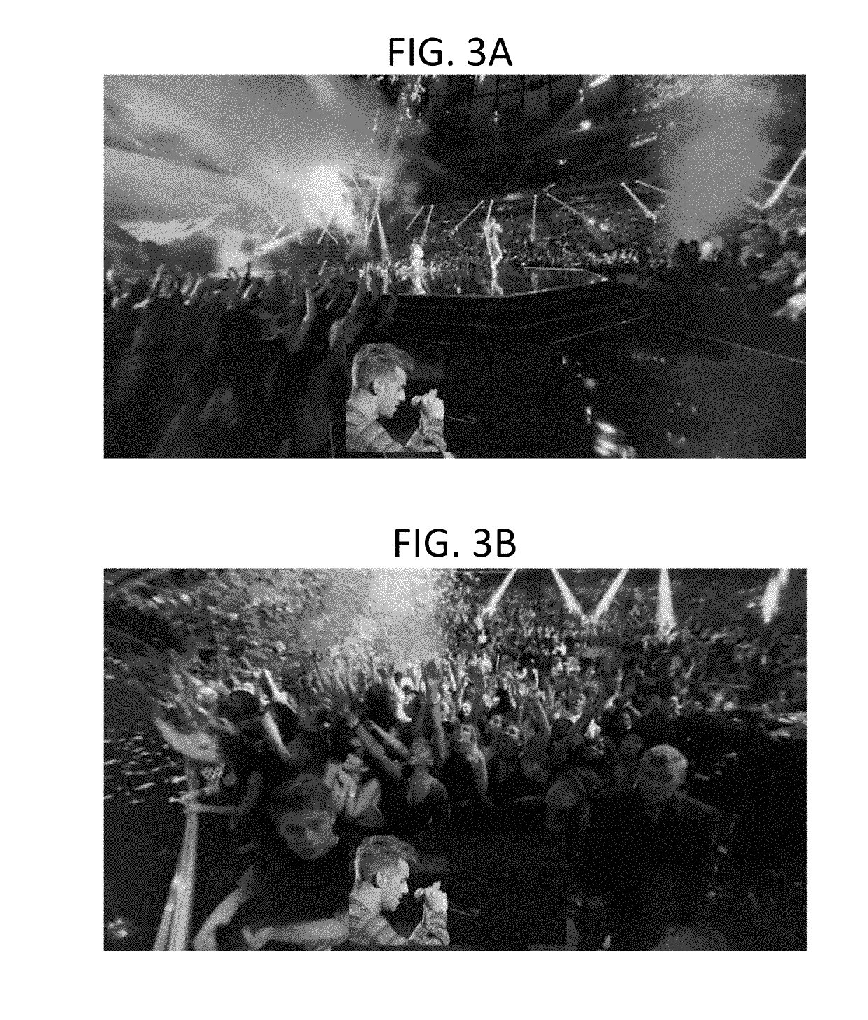

FIGS. 3-6 illustrate various aspects in accordance with a first example implementation. In particular, FIGS. 3A-B illustrate two end-user views or captures from a bundled video file of a music concert as viewed through the application 130. The perspectives, which each represent the same time or timestamp within the bundled video (and the counterpart individual videos), each show, in an outer video frame, a user-selected perspective of a 360 degree video of a music concert. Both perspectives were captured by the same 360 degree camera, but the end user has selected one perspective in FIG. 3A and another in FIG. 3B. The two perspectives can be viewed one after another by pausing the video and then using a mouse, touchpad or other input device to reorient the perspective from that of FIG. 3A to FIG. 3B.

FIGS. 3A-B also show, in addition, a smaller picture-in-picture format window, within the outer video frame, that contains a standard video feed of the concert, in this case highlighting the singer. As the video plays, the picture-in-picture window might change to show different camera views based on a director's selections of what to stream to viewers watching on a single screen. The end user of the application 130, however, can manipulate the outer video frame to obtain different perspectives from the 360 degree camera, synchronized to the standard video feed shown in the picture-in-picture window.

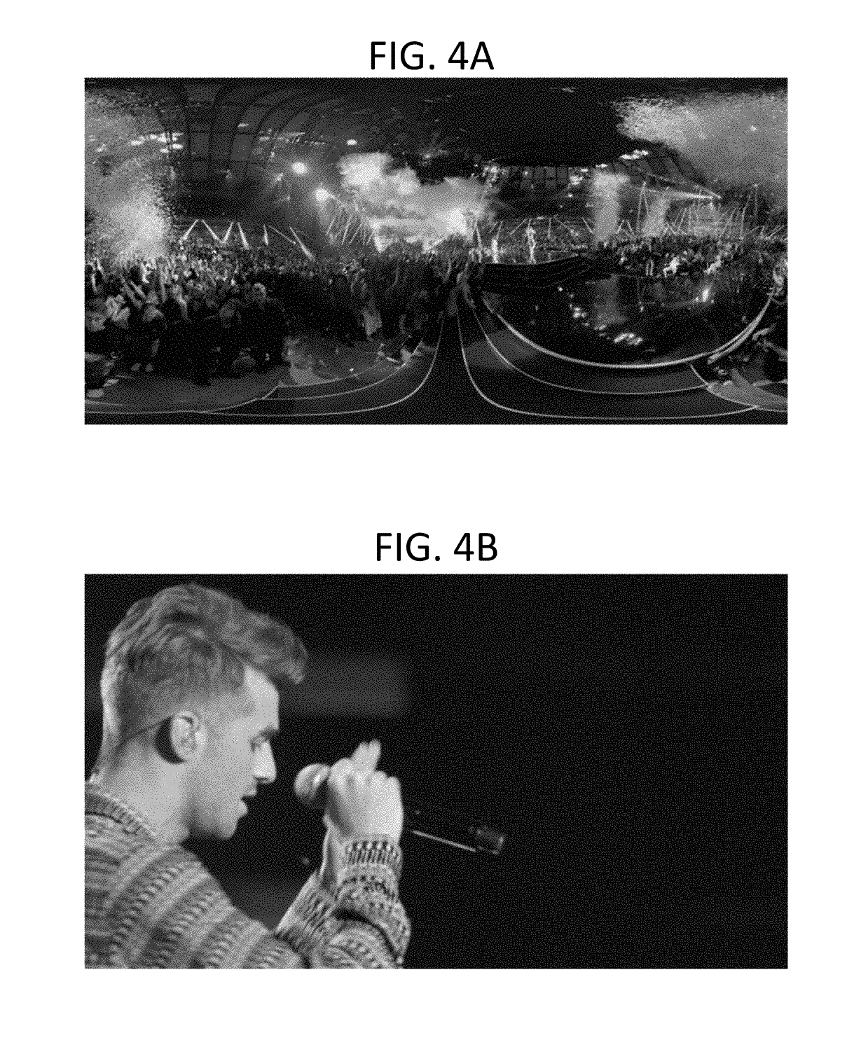

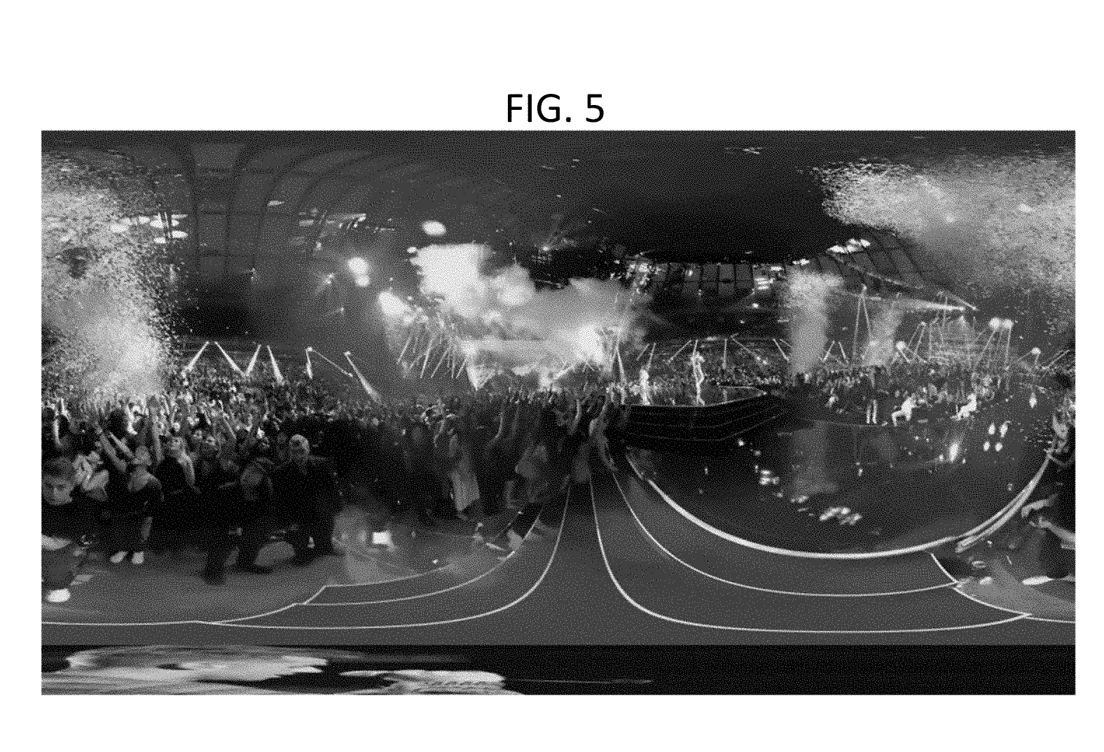

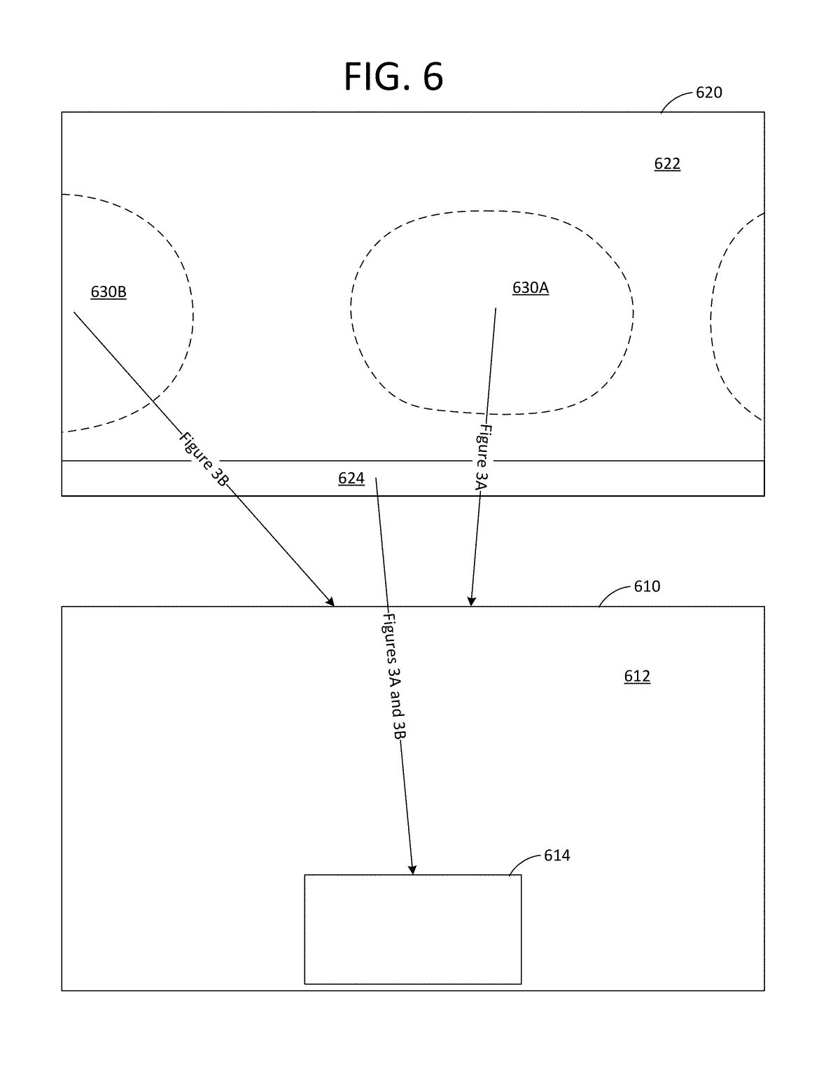

FIG. 4A shows a corresponding frame of an equirectangular projection from an individual video source file, as captured from a 360 degree camera, from which each of the perspectives shown in the FIGS. 3A and 3B could normally be obtained. FIG. 4B shows a corresponding frame of the standard video feed individual video source file from which the picture-in-picture feed would normally be obtained. FIG. 5 shows a corresponding frame of the bundled video file that is created from the 360 degree video source file and the standard video feed individual video source file. The 360 degree video source file is on the top of the bundled video frame while the standard video feed is on the bottom, resized to a lower vertical resolution since a higher resolution is not necessary to support the smaller picture-in-picture window.

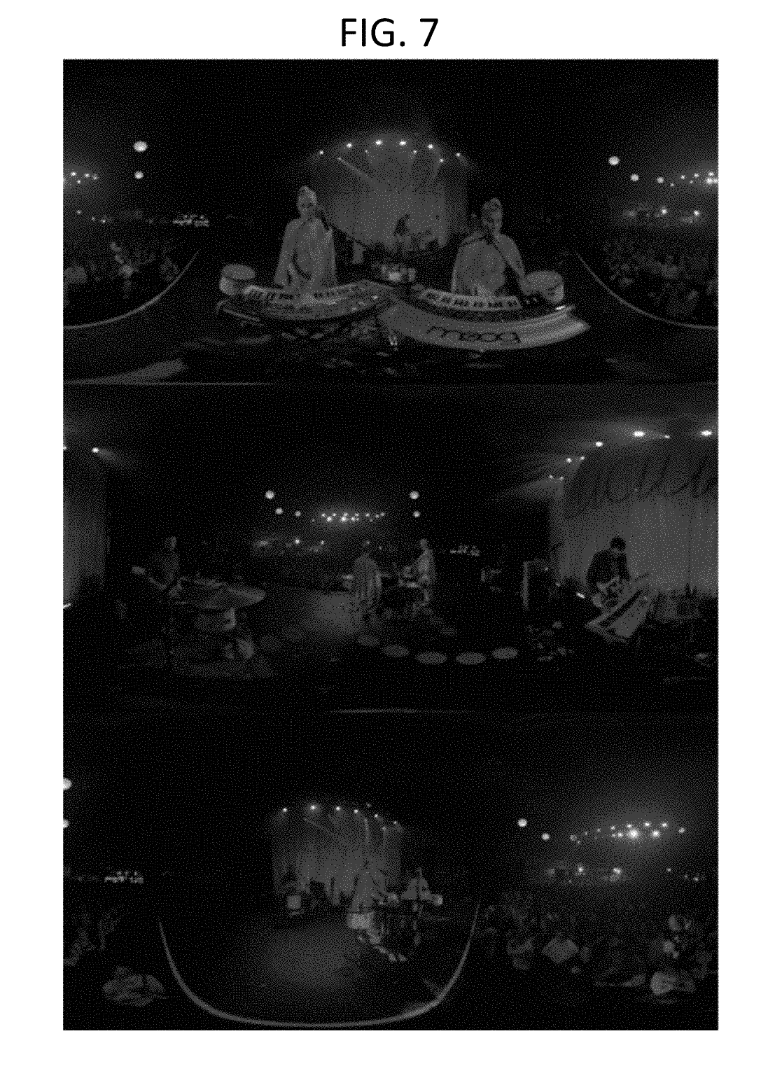

FIG. 6 illustrates a map 610 of the two end user views shown in FIGS. 3A-B. The map 610 of the end user views shows the outer video frame 612 as well as the smaller picture-in-picture window 614. FIG. 6 also shows a map 620 of the corresponding frame of the bundled video file shown in FIG. 5. The map 620 of the corresponding frame of the bundled video file shows the equirectangular projection 360 degree video source file 622 occupying the larger upper portion of the frame. The map 620 of the corresponding frame of the bundled video file also shows the standard video feed 624 occupying the smaller bottom portion of the frame. In order to create the bundled frame, the standard video feed is resized horizontally and then the equirectangular projection 360 degree video source is stacked vertically on top of the resized standard video feed. This can be done using standard ffmpeg filters.

As already noted, the standard video feed has been resized to a lower vertical resolution to save space in the bundled video frame. Optionally, the horizontal resolution of the standard video feed could have been compressed as well, but then other content or blank space would have been needed to fill the gap to create a rectangular bundled video frame.

The arrows in FIG. 6 show how portions or areas of pixels of the bundled video frame are mapped to the end user views shown in FIGS. 3A-B. As shown, the standard video feed 624 is taken from the bottom portion of a decoded bundled video frame. The portion from the bottom is readjusted to its normal aspect ratio and displayed in the picture-in-picture window 614 as shown in both FIGS. 3A and 3B. With respect to the outer frame, in each instance with respect to FIGS. 3A and 3B, the end user has used their controls to orient the 360 degree video towards a perspective indicated in the map 620. The area 630A of the equirectangular projection 360 degree video source file portion of the bundled video frame is mapped to form the outer video frame shown in FIG. 3A. The area 630B of the equirectangular projection 360 degree video source file portion of the bundled video frame is mapped to form the outer video frame shown in FIG. 3B. The process of mapping the portions of the 360 degree video source file is performed using known techniques that will be familiar to one skilled in the art.

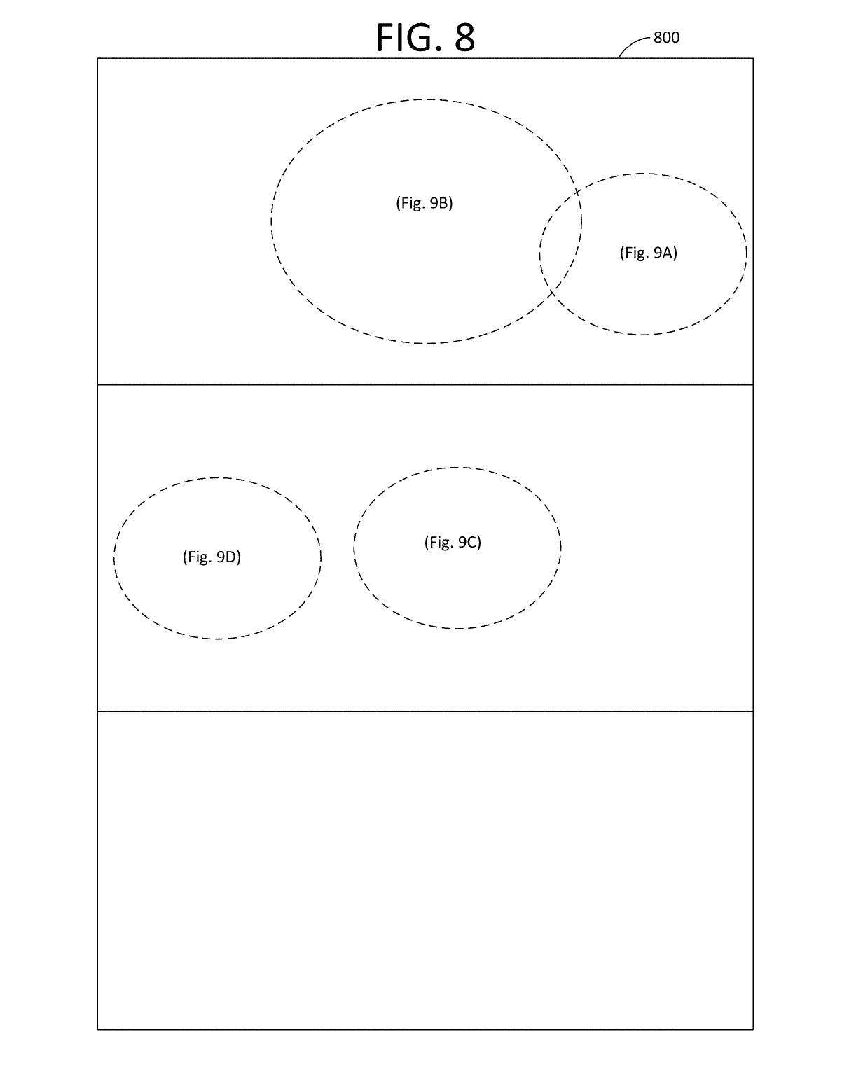

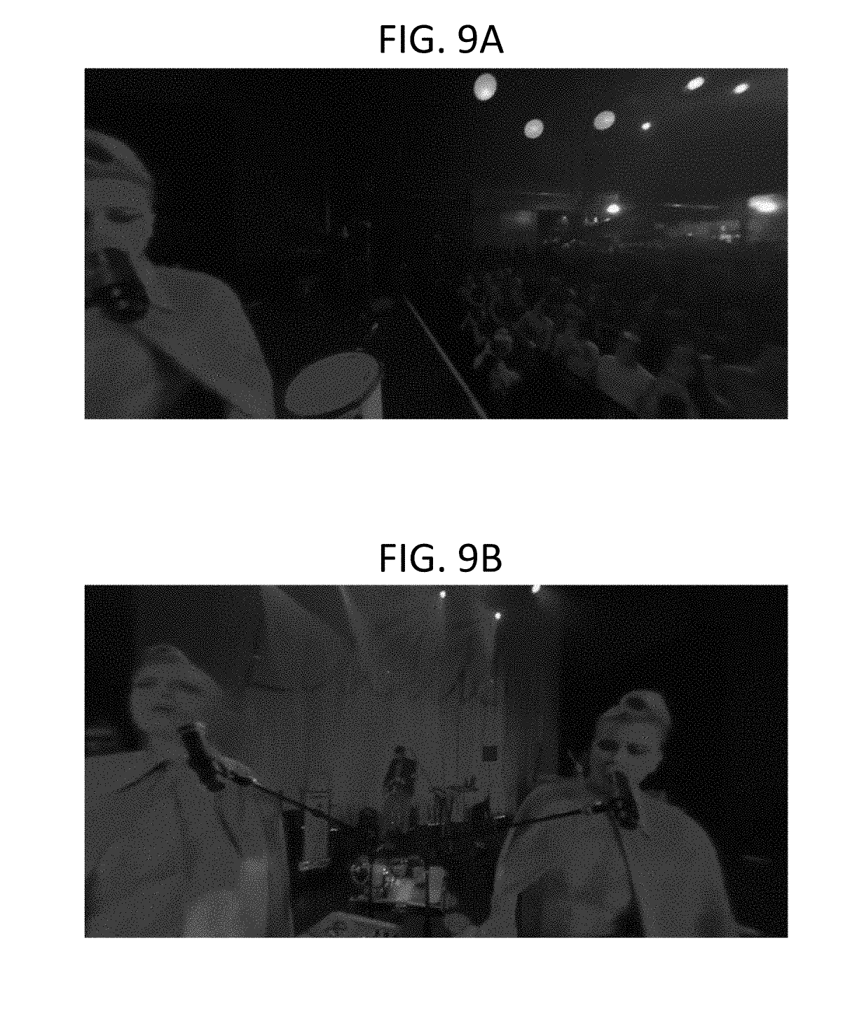

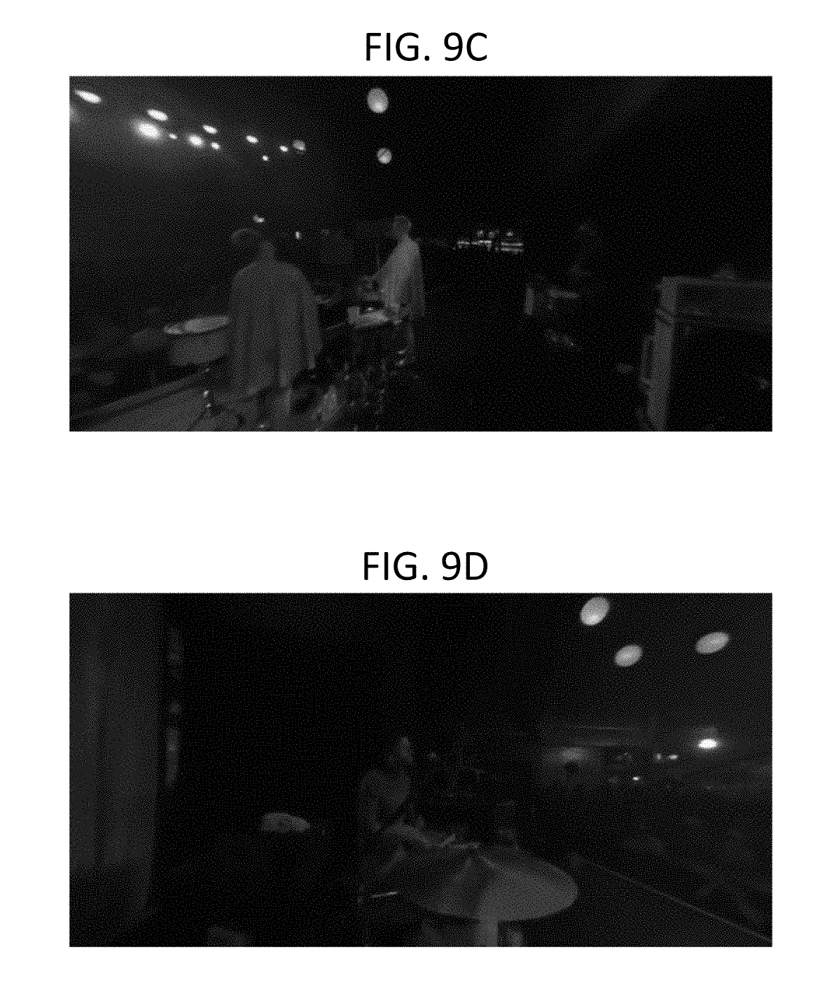

FIGS. 7-9 illustrate various aspects in accordance with a second example implementation. FIG. 7 illustrates a frame of a bundled video file that includes three equirectangular projection 360 degree video source files stacked vertically. The three video source files were recorded simultaneously at a single event using three separately placed 360 degree cameras. FIG. 8 illustrates a map 800 of the bundled video file showing how portions of the frame of FIG. 7 map to the views shown in FIGS. 9A-D. A user can use an input device with the end user application 130 to select among and also within the three 360 degree views.

As the video plays, a user can use a mouse, for example, to pan around starting from the perspective shown in FIG. 9A as reflected in the right portion of the uppermost source video shown in the map 800 of FIG. 8. The user then pans to the perspective shown in FIG. 9B as reflected at the center of the uppermost source video shown in the map 800 of FIG. 8. At this point, the user sees a small square icon in the center right portion of the video image. The square icon shows the physical position of another 360 degree camera that produced the source video for the middle of the three stacked videos in the bundled video file.

Since the source files produced by the 360 degree cameras remain stable over time, and do not pan, the coordinate location of a non-moving object within the field of view of one of the cameras can be identified within the frame of the 360 degree video source file. This coordinate location can then be recorded, such as in the video definition data 122 or in the presentation definition file 222. In this example, the recorded location is that of a second of three stationary 360 degree cameras and the location is highlighted by a selectable icon. When the coordinate location of the camera comes into the field of view of the end user as the end user pans, the selectable icon is displayed. When the user selects the selectable icon, the application 130 can immediately switch to showing to the user the perspective from the center of the three source videos in the bundled video. The transition between the two perspectives and switch between videos is assured to be smooth and without delay, since all three videos are being decoded from the same bundled source file. Audio will also remain synchronized.

As the video plays, now reflecting the perspective of the second of the three 360 degree cameras, the user can use the mouse to pan around from the perspective shown in FIG. 9C as reflected in the center portion of the middle source video shown in the map 800 of FIG. 8. The perspective shown in FIG. 9C also shows a selectable icon in the center left view indicating the location of the first camera from which the user just switched perspectives. The user can then pan to the left ending up at the perspective shown in FIG. 9D as reflected at the left portion of the middle source video shown in the map 800 of FIG. 8.

As will be appreciated by one skilled in the art, additional options for controlling videos included in a bundled video file can be provided to the end user by defining these options, for example, in a presentation definition file 222. For example, various user interface features can be presented to an end-user, within displayed video frames, or outside of displayed video frames for controlling access to videos within a bundled video file. Options can be presented for controlling or panning within 360 degree video files, for switching between video files seamlessly, and for simultaneously displaying multiple video files synchronized on a frame-by-frame basis optionally with synchronized audio. Multiple videos can be displayed picture-in-picture, side by side, above and below, or by resizing and random selection based on the desire of the end user. The end user application can be configured using known techniques to map appropriate portions of normal 2 dimensional or 360 degree videos from decoded frames of the bundled video file to the end-user requested locations. In all instances, synchronization between the multiple videos and their associated audio can be enforced based on the inclusion of the multiple individual video files in the bundled video file.

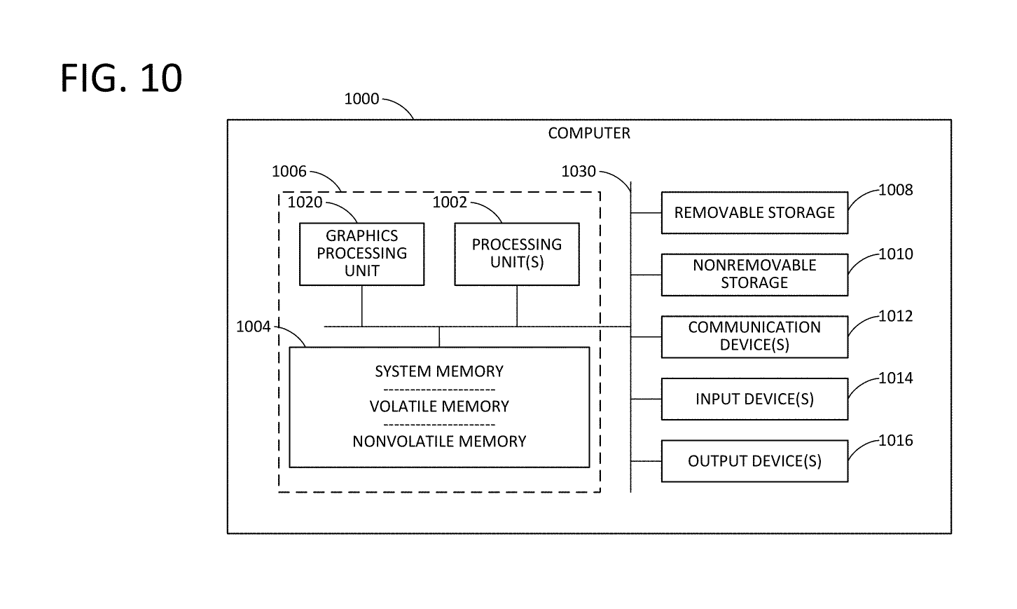

FIG. 10 illustrates an example computer 1000. Components of the embodiments disclosed herein, which may be referred to as modules, engines, processes, functions or the like, can be implemented by configuring one or more instances of the example computer using special purpose software or applications, possibly in different configurations and optionally networked, as a computer system. The computer 1000 can be any of a variety of general purpose computers such as, for example, a server, a desktop computer, a laptop computer or a mobile computing device.

On a general purpose computer, a processor typically executes computer programs which include an operating system and applications. The operating system is a computer program running on the computer that manages access to various resources of the computer by the applications and the operating system. The various resources generally include memory, storage, communication interfaces, input devices and output devices.

With reference to FIG. 10, the example computer 1000 includes at least one processing unit 1002 and memory 1004. The computer can have multiple processing units 1002 and multiple devices implementing the memory 1004. A processing unit 1002 can include one or more processors or processing cores (not shown) that operate independently of each other. Additional co-processing units, such as graphics processing unit 1020, also can be present in the computer. The memory 1004 may include volatile devices (such as dynamic random access memory (DRAM) or other random access memory device), and non-volatile devices (such as a read-only memory, flash memory, and the like) or some combination of the two. This configuration of memory is illustrated in FIG. 10 by dashed line 1006. The computer 1000 may include additional storage (removable and/or non-removable) including, but not limited to, magnetically-recorded or optically-recorded disks or tape. Such additional storage is illustrated in FIG. 10 by removable storage 1008 and non-removable storage 1010. The various components in FIG. 10 are generally interconnected by an interconnection mechanism, such as one or more buses 1030.

A computer storage medium is any medium in which data can be stored in and retrieved from addressable physical storage locations by the computer. Computer storage media includes volatile and nonvolatile memory devices, and removable and non-removable storage media. Memory 1004 and 1006, removable storage 1008 and non-removable storage 1010 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 1000 may also include communication device(s) 1012 through which the computer communicates with other devices over a communication medium such as a computer network. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals.

Communications device(s) 1012 can include, for example, a network interface or radio transmitter, that interface with the communication media to transmit data over and receive data from signals propagated through communication media. The communication device(s) 1012 can include one or more radio transmitters for telephonic communications over cellular telephone networks, and/or wireless connections to a computer network. For example, a cellular connection, a Wi-Fi connection, a Bluetooth connection, and other connections may be present in the computer. Such connections support communication with other devices, such as to support voice or data communications.

The computer 1000 may have various input device(s) 1014 such as a keyboard, mouse, touchscreen and pen, image input devices, such as still and motion cameras, audio input devices, such as a microphone, and various sensors, such as accelerometers, thermometers and magnetometers. Output device(s) 1016 such as a display, speakers, printers, and so on, also may be included.

The various storage 1010, communication device(s) 1012, output devices 1016 and input devices 1014 can be integrated within a housing of the computer, or can be connected through various input/output interface devices on the computer, in which case the reference numbers 1010, 1012, 1014 and 1016 can indicate either the interface for connection to a device or the device itself as the case may be.

An operating system of the computer typically includes computer programs, commonly called drivers, that manage access to the various storage 1010, communication device(s) 1012, output devices 1016 and input devices 1014. Such access generally includes managing inputs from and outputs to these devices. In the case of communication device(s), the operating system also may include one or more computer programs for implementing communication protocols used to communicate information between computers and devices through the communication device(s) 1012.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs may be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Program-specific Integrated Circuits (ASICs), Program-specific Standard Products (ASSPs), System-on-a-chip systems (SOCs), and Complex Programmable Logic Devices (CPLDs).

Although the subject matter has been described in terms of certain embodiments, other embodiments, including embodiments which may or may not provide various features and advantages set forth herein will be apparent to those of ordinary skill in the art in view of the foregoing disclosure. The specific embodiments described above are disclosed as examples only, and the scope of the patented subject matter is defined by the claims that follow.

In the claims, the terms “based upon” or “based on” shall include situations in which a factor is taken into account directly and/or indirectly, and possibly in conjunction with other factors, in producing a result or effect. In the claims, a portion shall include greater than none and up to the whole of a thing. In method claims, any reference characters are used for convenience of description only, and do not indicate a particular order for performing a method.

1. A method comprising:
positionally stacking time-correlated frames of a plurality of video source files to create an encoded bundled video file;
for each of the plurality of video source files, storing position data that specifies a positional location of the frames of the video source file within frames of the bundled video file;
decoding the encoded bundled video file;
accessing the stored position data for at least one of the video source files;
based on the accessed position data, mapping a first area of pixels from the decoded bundled video file for display in a user interface;
receiving user input subsequent to the mapping a first area of pixels; and
based on the received user input and based on the accessed position data, mapping a second area of pixels from the decoded bundled video file for display in the user interface.

2. The method of claim 1, wherein the bundled video file comprises a plurality of encoded frames, and wherein each encoded frame contains video content representing at least a portion of each of the plurality of video source files.

3. The method of claim 1, wherein the position data is stored in a data file, the method further comprising accessing the data file to retrieve the position data for at least one of the video source files.

4. The method of claim 1, wherein the first area of pixels from the decoded bundled video file is displayed in the user interface in an area that overlays at least a portion of an area in the user interface in which the second area of pixels from the decoded bundled video file is displayed.

5. The method of claim 1, wherein the first area of pixels and the second area of pixels from the decoded bundled video file are displayed simultaneously in the user interface.

6. The method of claim 1, wherein the second area of pixels from the decoded bundled video file replaces the first area of pixels from the decoded bundled video file in the user interface.

7. The method of claim 1, wherein the user input comprises selection of an icon overlaying the first area of pixels as mapped for display in the user interface, wherein the icon is associated with a position, within the first area of pixels, of a camera that captured the second area of pixels.

8. The method of claim 1, wherein the first area of pixels is associated with a first of the plurality of video source files, and wherein the second area of pixels is associated with a second of the plurality of video source files.

9. The method of claim 1, wherein the position data comprises coordinate locations within a frame.

10. A system comprising:
an authoring computing device configured for:
positionally stacking time-correlated frames of a plurality of video source files to create an encoded bundled video file, and
for each of the plurality of video source files, storing position data that specifies a positional location of the frames of the video source file within frames of the bundled video file;
a database storing presentation data files comprising the position data; and
an end user computing device configured for:
decoding the encoded bundled video file,
accessing the stored position data for at least one of the video source files, based on the accessed position data, mapping a first area of pixels from the decoded bundled video file for display in a user interface,
receiving user input subsequent to the mapping a first area of pixels, and
based on the received user input and based on the accessed position data, mapping a second area of pixels from the decoded bundled video file for display in the user interface.

11. A set of one or more non-transitory computer readable media storing instructions that when executed by one or more computing devices cause the computer devices to:
positionally stack time-correlated frames of a plurality of video source files to create an encoded bundled video file;
for each of the plurality of video source files, store position data that specifies a positional location of the frames of the video source file within frames of the bundled video file;
decode the encoded bundled video file;
access the stored position data for at least one of the video source files;
based on the accessed position data, map a first area of pixels from the decoded bundled video file for display in a user interface;
receive user input subsequent to the mapping a first area of pixels; and
based on the received user input and based on the accessed position data, map a second area of pixels from the decoded bundled video file for display in the user interface.
